(19) United States
(12) Patent Application Publication
(10) Pub. No.: US 2026/0019707 A1
(43) Pub. Date: Jan. 15, 2026

(54) OPTICAL ELEMENT DRIVE MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Yu-Chi KUO, Taoyuan City (TW); Ya-Hsiu WU, Taoyuan City (TW)

(21) Appl. No.: 18/795,495

(22) Filed: Aug. 6, 2024

(30) Foreign Application Priority Data
Jul. 12, 2024 (CN) 202410934696.9

(51) Int. Cl. H04N 23/68; H04N 23/54

(52) U.S. Cl. CPC H04N 23/687; H04N 23/54; H04N 23/6812

(57) ABSTRACT

An optical element drive mechanism is provided. The optical element drive mechanism includes an immovable part, a movable part, a drive assembly, and a stopper assembly. The movable part is connected to an optical element. The movable part is movable relative to the immovable part. The drive assembly drives the movable part to move relative to the immovable part. The stopper assembly restricts the movement of the movable part within a range of motion. The stopper assembly includes a first stopper element. The first stopper element is connected to the immovable part.

### CROSS REFERENCE TO RELATED APPLICATIONS

This Application claims priority of China Patent Application No. 2024109346969, filed on Jul. 12, 2024, the entirety of which is incorporated by reference herein.

### BACKGROUND OF THE INVENTION

### Field of the Invention

The present disclosure relates to an optical element drive mechanism, and, in particular to an optical element drive mechanism that can restrict the movement of a movable part.

### Description of the Related Art

Advancements in technology have allowed many electronic devices (e.g., smartphones or tablets) to shoot photo and record video due to the optical elements and optical element drive mechanisms that are installed inside. An optical element drive mechanism capable of correcting shakes and vibrations has been developed to improve the quality of these photos and videos.

### BRIEF SUMMARY OF THE INVENTION

Some embodiments of the present disclosure provide an optical element drive mechanism. The optical element drive mechanism includes an immovable part, a movable part, a drive assembly, and a stopper assembly. The movable part is connected to an optical element, wherein the movable part is movable relative to the immovable part. The drive assembly drives the movable part to move relative to the immovable part. The stopper assembly restricts the movable part to move within a range of motion. The stopper assembly includes a first stopper element connected to the immovable part.

In some embodiments, the movable part includes a first corner element disposed over the first stopper element, and when the movable part is located at a lower limit position, the first corner element is in direct contact with the first stopper element. In some embodiments, the first stopper element is made of metal. In some embodiments, the first corner element is substantially L-shaped. In some embodiments, the movable part further includes a second corner element, the first corner element and the second corner element are located on different corners of the optical element drive mechanism, and when the movable part is located at the lower limit position, the second corner element is in direct contact with the first stopper element. In some embodiments, the movable part further includes an extending element, the first corner element is connected to the second corner element via the extending element, and a thickness of the first corner element is different from a thickness of the extending element.

In some embodiments, the thickness of the first corner element is greater than the thickness of the extending element. In some embodiments, the first corner element and the extending element are made of different materials. In some embodiments, the first corner element and the second corner element are made of plastic, and the extending element is made of metal.

In some embodiments, the immovable part includes a casing. The casing includes a top wall and a side wall connected to the top wall and not parallel with the top wall. The top wall and the side wall form an accommodating space for accommodating the movable part and the stopper assembly. The first stopper element includes a first connection portion and a second connection portion, the first connection portion and the second connection portion are located on different sides of the optical element drive mechanism, and the first connection portion and the second connection portion are firmly connected to the casing.

In some embodiments, the stopper assembly further includes a second stopper element, the first stopper element and the second stopper element are located on different sides of the optical element drive mechanism, and the first stopper element and the second stopper element have plate-like structures. In some embodiments, the first stopper element and the second stopper element are made of metal, and the first stopper element and the second stopper element are welded to the casing. In some embodiments, the first stopper element and the second stopper element are made of plastic, and the first stopper element and the second stopper element are firmly connected to the casing via an adhesive element.

In some embodiments, the drive assembly includes a first coil and a first magnetic element corresponding to the first coil, and when the movable part is located at an upper limit position, the first magnetic element is in direct contact with the first coil. In some embodiments, in the main axis, the minimum distance between the first coil and the first magnetic element is different from the minimum distance between the first stopper element and the first corner element. In some embodiments, the drive assembly further includes a second coil and a third coil, the first coil, the second coil, and the third coil are disposed on different sides of the optical element drive mechanism, and the first coil, the second coil, and the third coil have different sizes along their respective long axes.

In some embodiments, the optical element drive mechanism further includes a sensing assembly. The sensing assembly includes a first sensing element disposed inside the first coil, a second sensing element disposed inside the second coil, and a third sensing element disposed inside the third coil. In some embodiments, the optical element drive mechanism further includes a support assembly. The support assembly includes a first support element extending along the main axis, a top end of the first support element is connected to the immovable part, and a bottom end of the first support element is connected to the movable part. In some embodiments, the first support element and the first corner element are disposed at the same corner of the optical element drive mechanism, and the first support element is disposed at an inner side of the first corner element. In some embodiments, the support assembly further includes an elastic element, and the elastic element includes a first suspension portion connected to the first support element.

### BRIEF DESCRIPTION OF THE DRAWINGS

The present disclosure can be more fully understood by reading the detailed description and examples with references made to the accompanying drawings. It should be noted that various features may be not drawn to scale. In fact, the dimensions of the various features may be arbitrarily increased or decreased for clarity of discussion, and the various features may be drawn schematically.

FIG. 1 is a perspective view of the optical element drive mechanism according to some embodiments.

FIG. 2 is a top view of the optical element drive mechanism according to some embodiments.

FIG. 3 is a bottom view of the optical element drive mechanism according to some embodiments.

FIG. 4 is an exploded view of the optical element drive mechanism according to some embodiments.

FIG. 5 and FIG. 6 are perspective views of the holder from different perspectives according to some embodiments.

FIG. 7 and FIG. 8 are perspective views of the optical element drive mechanism with the casing omitted according to some embodiments.

FIG. 9 is a top view of the optical element drive mechanism with the casing omitted according to some embodiments.

FIG. 10 is a bottom view of the optical element drive mechanism with the casing omitted according to some embodiments.

FIG. 11 and FIG. 12 are perspective views of the optical element drive mechanism with the casing and the holder omitted according to some embodiments.

FIG. 13 and FIG. 14 are perspective views of the optical element drive mechanism with the casing, the holder, and the circuit assembly omitted according to some embodiments.

FIG. 15 and FIG. 16 are side views of the optical element drive mechanism with the casing, the holder, and the circuit assembly omitted according to some embodiments.

### DETAILED DESCRIPTION OF THE INVENTION

The following description provides different embodiments, or examples, for implementing different features of the present disclosure. For example, the formation of a first feature “on” or “over” a second feature in the following description may include embodiments in which the first and second features are formed in direct contact, and may also include embodiments in which additional features may be formed between the first feature and the second feature, such that the first feature and the second feature are not in direct contact.

In addition, spatially relative terms may be used in the following description to describe the arrangements of various features. These spatially relative terms are for ease of describing the positional relationship between one feature and another feature as illustrated in the drawings. These spatially relative terms are intended to encompass different orientations of the device in use or operation in addition to the orientation illustrated in the drawings. The device may be otherwise oriented (rotated 90 degrees or at other orientations), and the spatially relative terms used in the following description may likewise be interpreted accordingly. For example, if a device of the drawings is flipped upside down, a feature that is “above” will become a feature that is “below”.

In the following description, the terms “including”, “comprising”, “having”, and the like should be interpreted as meaning “including but not limited to . . . ”. Therefore, when the terms “including”, “comprising”, “having”, and the like are used, the presence of corresponding features, regions, steps, operations and/or elements is specified, and without excluding the presence of other features, regions, steps, operations and/or elements.

Ordinal terms such as “first”, “second”, etc., used in the description and claims do not by themselves connote any priority, precedence, or order of one feature over another, but are used merely as labels to distinguish one feature from another feature having the same name. Therefore, a first feature in the description may be referred to as a second feature in claims. In addition, the following description may repeat reference numerals and/or letters in the various examples. This repetition is for the purpose of simplicity and clarity, and the repetition does not in itself dictate a relationship between the various embodiments and/or configurations discussed.

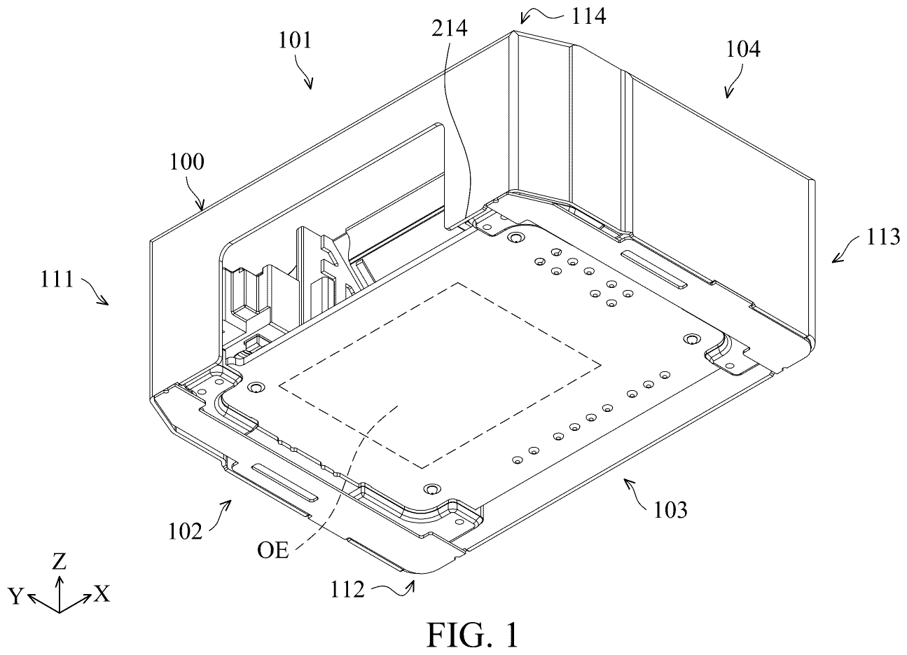

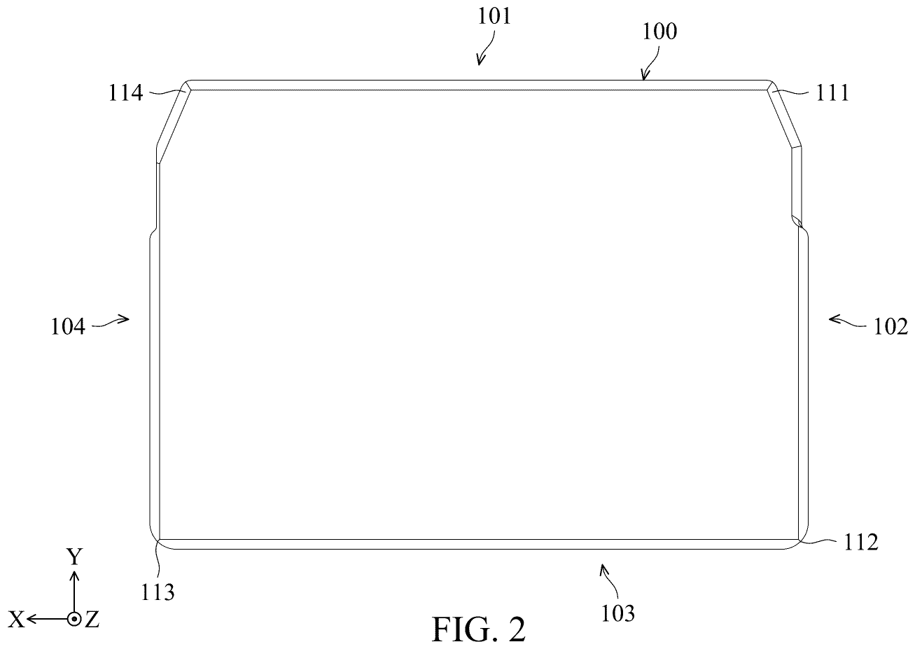

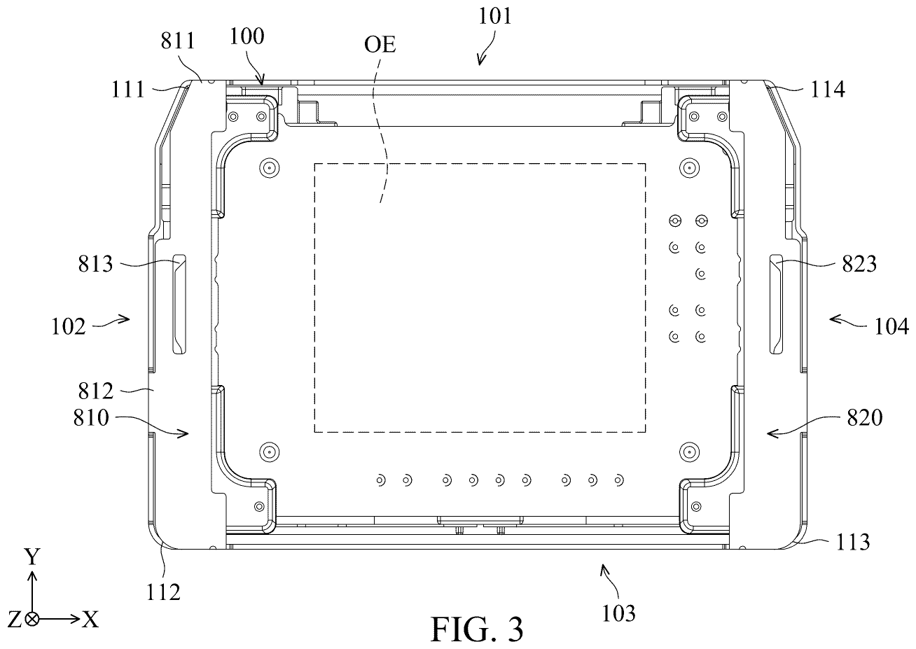

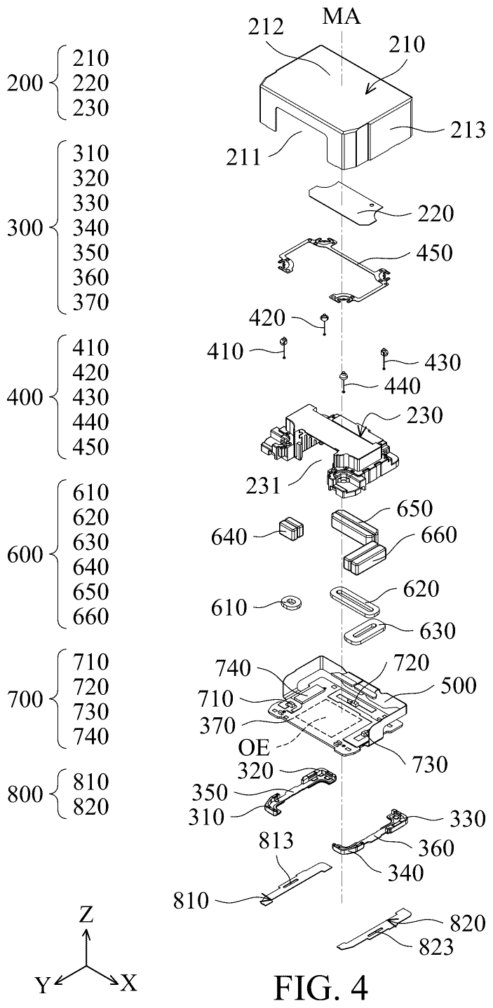

Please refer to FIG. 1 to FIG. 4 to understand an optical element drive mechanism 100. FIG. 1 is a perspective view of the optical element drive mechanism 100 according to some embodiments. FIG. 2 is a top view of the optical element drive mechanism 100 according to some embodiments. FIG. 3 is a bottom view of the optical element drive mechanism 100 according to some embodiments. FIG. 4 is an exploded view of the optical element drive mechanism 100 according to some embodiments. For convenience of explanation, the central axis of the optical element drive mechanism 100 is defined as the main axis MA.

The optical element drive mechanism 100 can drive an optical element OE to move. The optical element OE can be an image sensor, such as a charge-coupled device (CCD), a complementary metal oxide semiconductor (CMOS) image sensor (CIS), etc. Light can be imaged on the optical element OE. Using the optical element drive mechanism 100 to drive the optical element OE can be referred to as “sensor-shift” technology in this technical field. In some embodiments, the optical element OE can be a lens, a filter, etc.

From a top view, the optical element drive mechanism 100 is polygonal. In the following description, the four sides of the optical element drive mechanism 100 are respectively defined as the first side 101, the second side 102, the third side 103, and the fourth side 104. The first side 101 is opposite to the third side 103, and the second side 102 is opposite to the fourth side 104. Furthermore, in the following description, the four corners of the optical element drive mechanism 100 are defined as the first corner 111, the second corner 112, the third corner 113, and the fourth corner 114. The first corner 111 is located between the first side 101 and the second side 102, the second corner 112 is located between the second side 102 and the third side 103, the third corner 113 is located between the third side 103 and the fourth side 104, and the fourth corner 114 is located between the fourth side 104 and the first side 101.

The optical element drive mechanism 100 includes an immovable part 200, a movable part 300, a support assembly 400, a circuit assembly 500, a drive assembly 600, a sensing assembly 700, and a stopper assembly 800. However, the elements included in the optical element drive mechanism 100 can be added or omitted if needed.

The immovable part 200 includes a casing 210, a plate-like element 220, and a holder 230. The casing 210 includes a casing opening 211, a top wall 212, a plurality of side walls 213, and a protruding portion 214 (only denoted in FIG. 1). The casing opening 211 is formed on the first side 101 of the optical element drive mechanism 100. Light can enter the optical element drive mechanism 100 through the casing opening 211.

The top wall 212 is perpendicular to the main axis MA. The side walls 213 are connected to the top wall 212, and the side walls are not parallel with the top wall 212. In some embodiments, the side walls 213 extend from the edge of the top wall 212 in a direction parallel with the main axis MA. The top wall 212 and the side walls 213 can form an accommodating space to accommodate the movable part 300, the support assembly 400, the circuit assembly 500, the drive assembly 600, the sensing assembly 700, and the stopper assembly 800. The plate-like element 220 is disposed between the casing 210 and the holder 230. In some embodiments, the plate-like element 220 is made of metal.

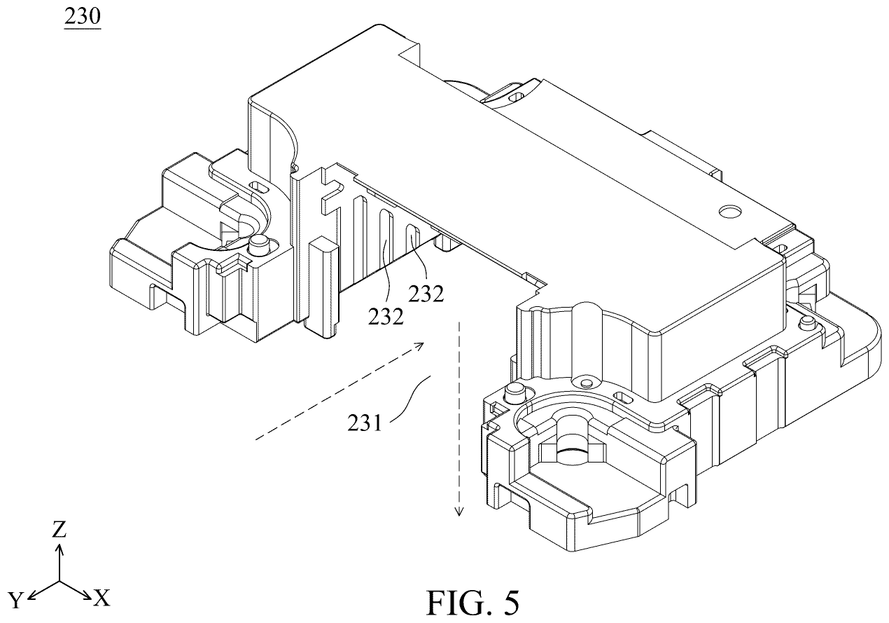

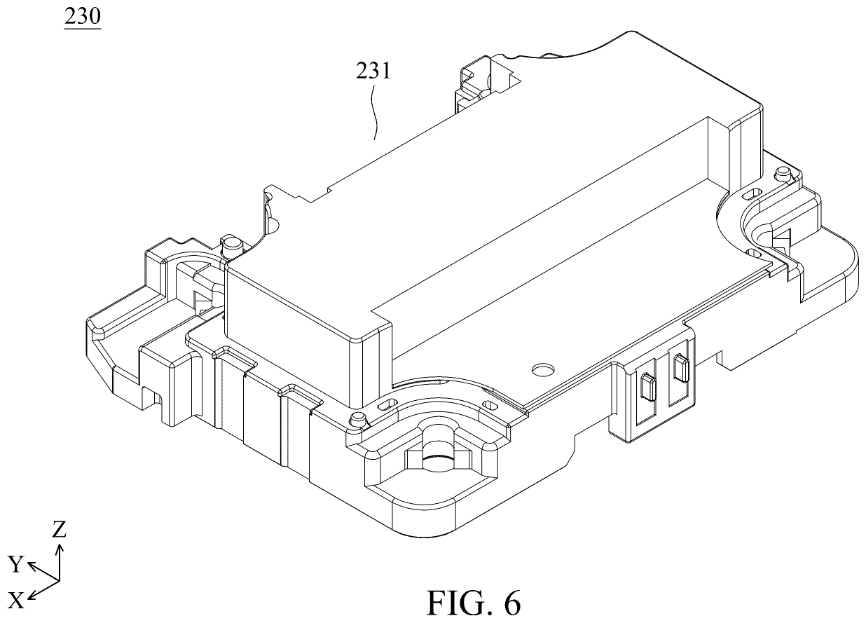

Next, in addition to FIG. 1 to FIG. 4, please also refer to FIG. 5 and FIG. 6 to understand the holder 230. FIG. 5 and FIG. 6 are perspective views of the holder 230 from different perspectives according to some embodiments. In some embodiments, from a top view, the holder 230 is U-shaped, and the open end of the U-shape faces the first side 101 of the optical element drive mechanism 100. In some embodiments, circuits can be formed in the holder 230 through insert molding.

The holder 230 includes a holder opening 231 and a plurality of holder grooves 232. The holder opening 231 is formed on the first side 101 of the optical element drive mechanism 100. Light can enter the holder opening 231 after passing through the casing opening 211. The internal space of the holder 230 can accommodate an optical path adjustment element (e.g., prism or mirror), which can change the travel direction of light. An adhesive element (e.g., glue) can be placed in the holder grooves 232 to strengthen the connection between the holder 230 and the optical path adjustment element. The travel direction of light is illustrated in dashed lines in FIG. 5. For example, after light enters the holder opening 231, it can be adjusted by the optical path adjustment element to exit the holder 230 from the bottom surface of the holder 230 and reach the optical element OE.

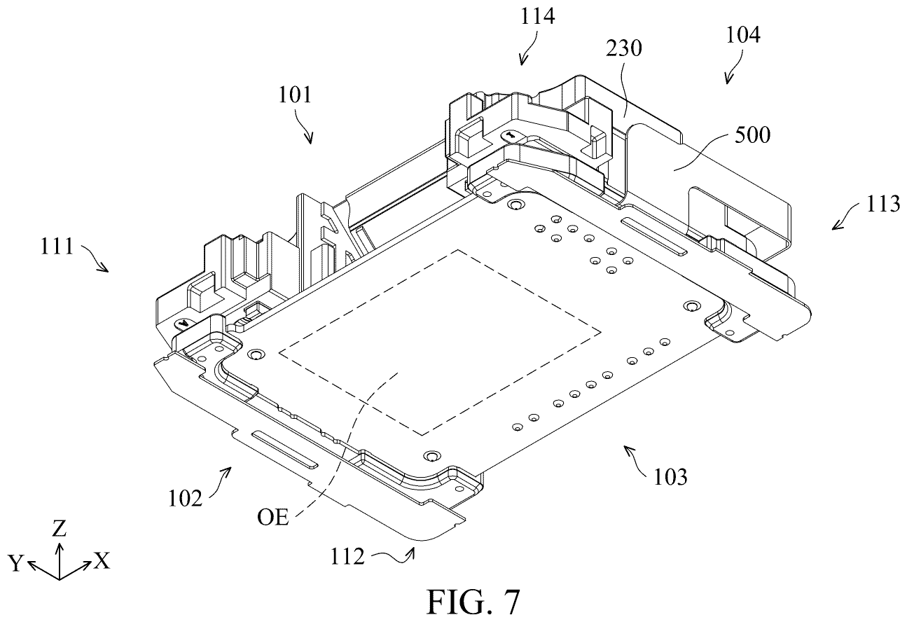

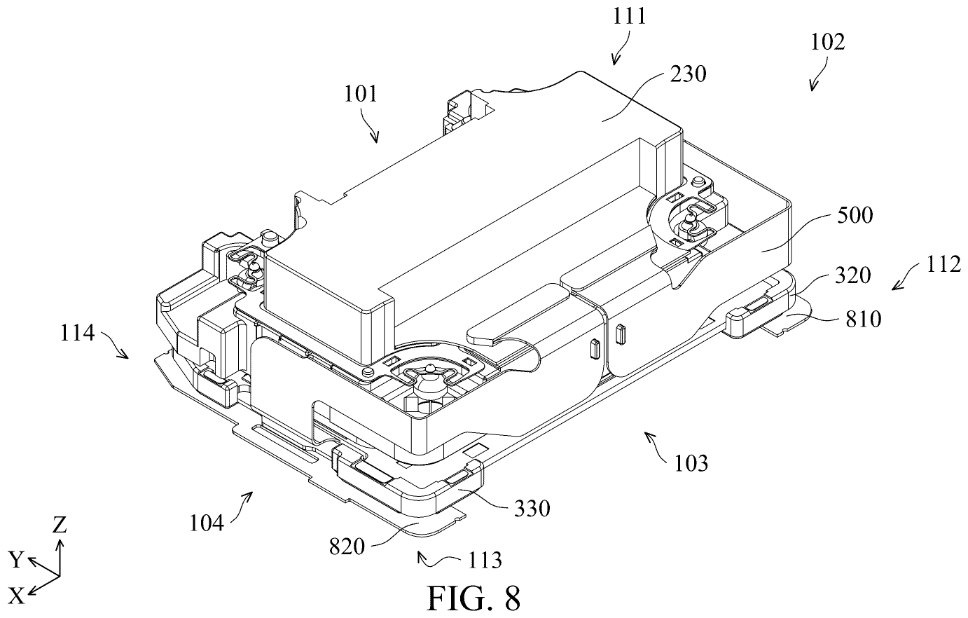

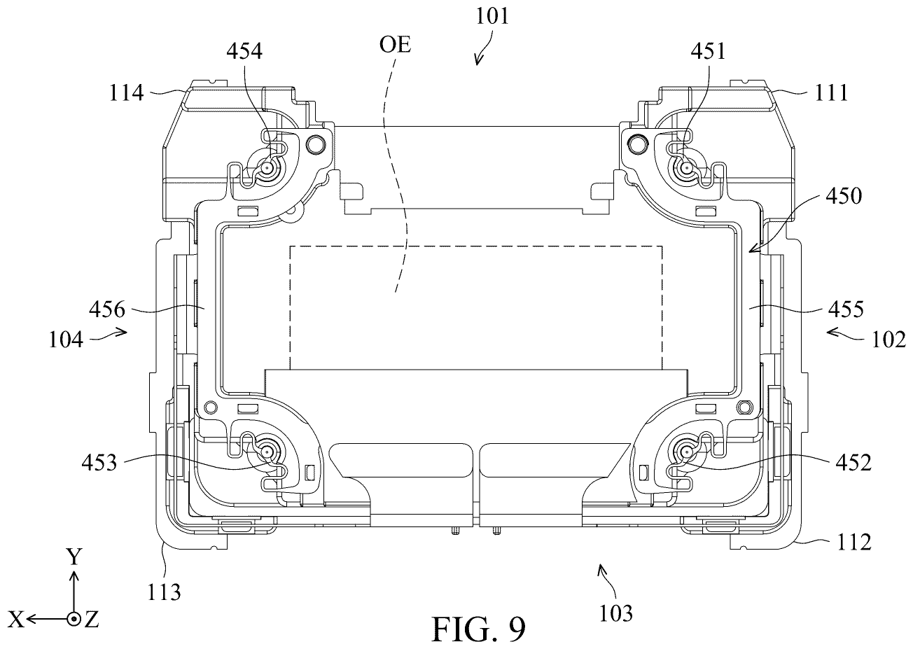

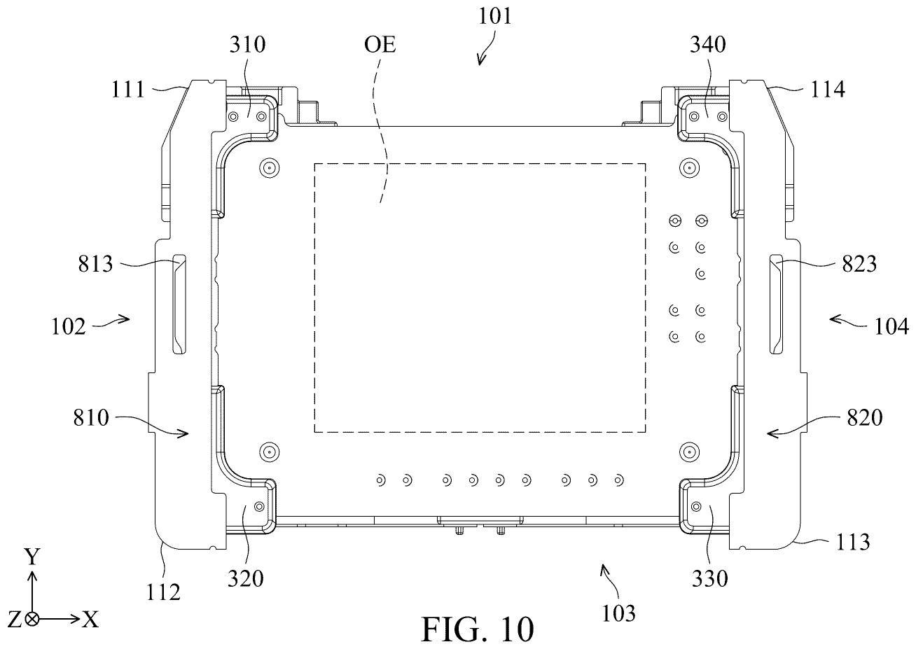

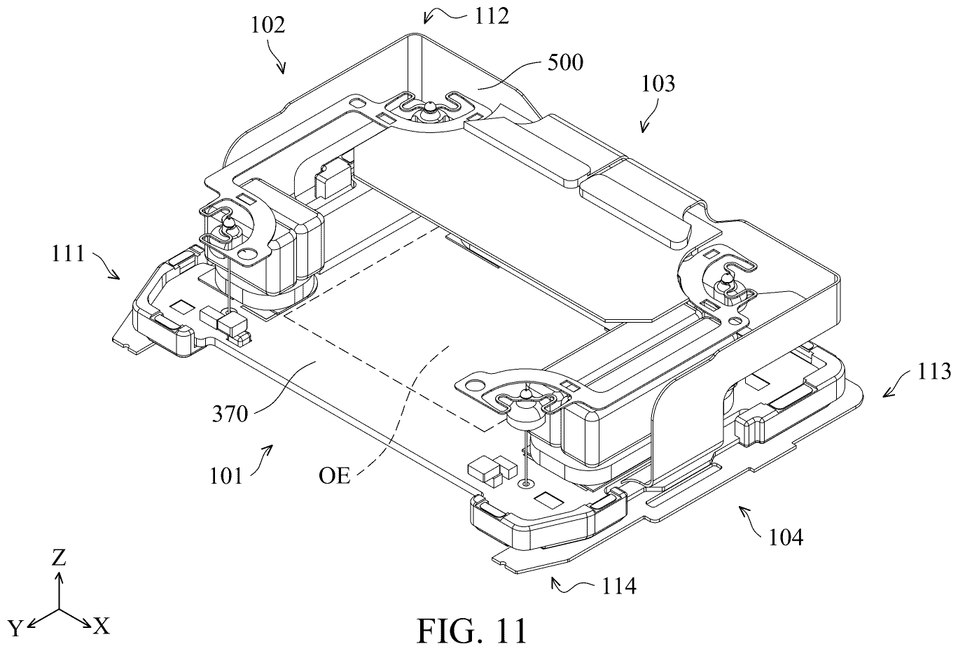

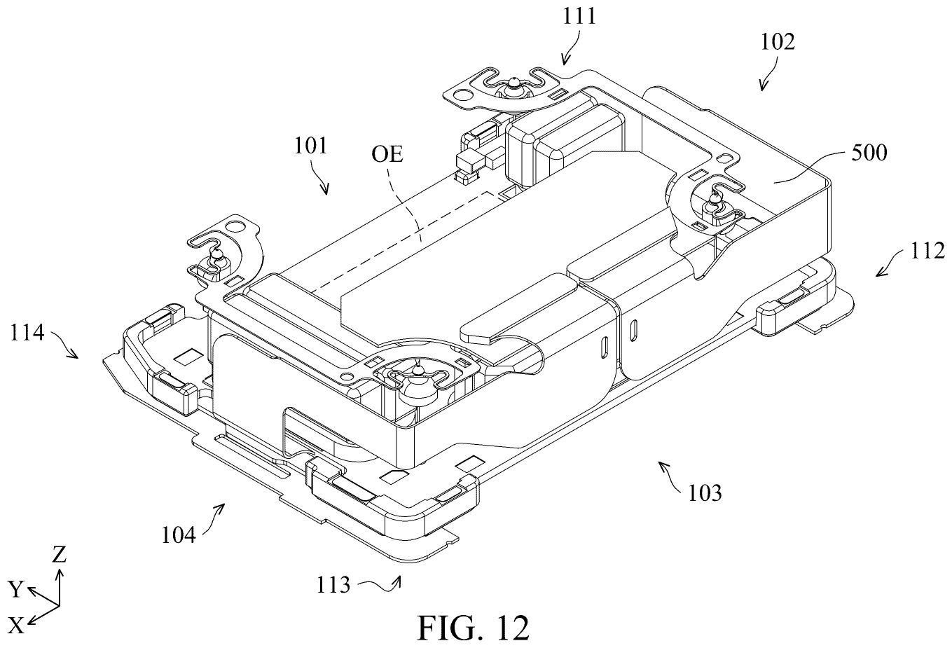

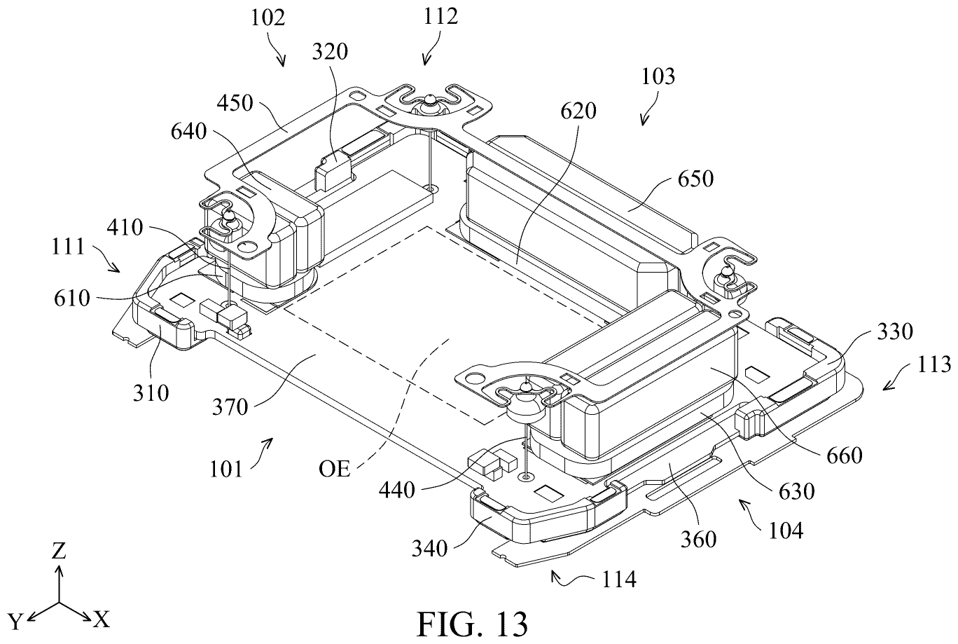

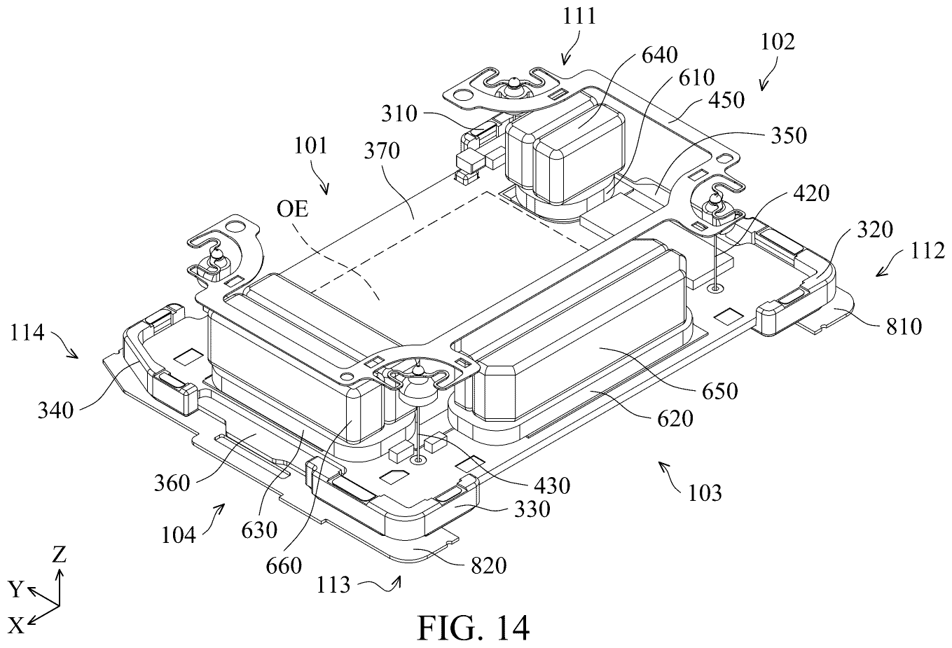

Next, please refer to FIG. 1 to FIG. 4 and FIG. 7 to FIG. 14 to understand the movable part 300, the support assembly 400, the circuit assembly 500, the drive assembly 600, and the sensing assembly 700. FIG. 7 and FIG. 8 are perspective views of the optical element drive mechanism 100 with the casing 210 omitted according to some embodiments. FIG. 9 is a top view of the optical element drive mechanism 100 with the casing 210 omitted according to some embodiments. FIG. 10 is a bottom view of the optical element drive mechanism 100 with the casing 210 omitted according to some embodiments. FIG. 11 and FIG. 12 are perspective views of the optical element drive mechanism 100 with the casing 210 and the holder 230 omitted according to some embodiments. FIG. 13 and FIG. 14 are perspective views of the optical element drive mechanism 100 with the casing 210, the holder 230, and the circuit assembly 500 omitted according to some embodiments.

The movable part 300 includes a first corner element 310, a second corner element 320, a third corner element 330, a fourth corner element 340, a first extending element 350, a second extending element 360, and a circuit substrate 370.

The first corner element 310, the second corner element 320, the third corner element 330, and the fourth corner element 340 are arranged around the circuit substrate 370. The first corner element 310, the second corner element 320, the third corner element 330, and the fourth corner element 340 are respectively disposed at different corners of the optical element drive mechanism 100. Specifically, the first corner element 310 is disposed at the first corner 111 of the optical element drive mechanism 100. The second corner element 320 is disposed at the second corner 112 of the optical element drive mechanism 100. The third corner element 330 is disposed at the third corner 113 of the optical element drive mechanism 100. The fourth corner element 340 is disposed at the fourth corner 114 of the optical element drive mechanism 100.

The first extending element 350 extends along the second side 102 of the optical element drive mechanism 100, and the first corner element 310 is connected to the second corner element 320 via the first extending element 350. The second extending element 360 extends along the fourth side 104 of the optical element drive mechanism 100, and the third corner element 330 is connected to the fourth corner element 340 via the second extending element 360.

In some embodiments, the first corner element 310, the second corner element 320, the third corner element 330, and the fourth corner element 340 are substantially the same, having the same or similar shapes or sizes (e.g., thickness). In some embodiments, the first corner element 310 is shaped like an L-shape. In some embodiments, the first extending element 350 and the second extending element 360 are substantially the same, having the same or similar shape or dimensions (e.g., thickness).

In some embodiments, the thickness of first corner element 310 is different from the thickness of first extending element 350. In some embodiments, the thickness of first corner element 310 is greater than the thickness of first extending element 350. In some embodiments, the first corner element 310 is made of a different material than the first extending element 350. In some embodiments, the first corner element 310 is made of plastic, and the first extending element 350 is made of metal.

The circuit substrate 370 may be used to be connected the optical element OE. In some embodiments, instead of directly mounting the optical element OE to the optical element drive mechanism 100, the optical element OE is first disposed in an optical element unit, and the optical element unit including the optical element OE is mounted to the circuit substrate 370 to install the optical element OE to the optical element drive mechanism 100.

The support assembly 400 includes a first support element 410, a second support element 420, a third support element 430, a fourth support element 440, and an elastic element 450. The first support element 410, the second support element 420, the third support element 430, and the fourth support element 440 extend along the main axis MA. One end (for example, the top end) of the first support element 410, the second support element 420, the third support element 430, and the fourth support element 440 is connected to the holder 230. In addition, the other end (for example, the bottom end) of the first support element 410, the second support element 420, the third support element 430, and the fourth support element 440 is connected to the circuit substrate 370.

Specifically, the first support element 410 is disposed at the first corner 111 of the optical element drive mechanism 100, and the first support element 410 is located at the inner side of the first corner element 310. The second support element 420 is disposed at the second corner 112 of the optical element drive mechanism 100, and the second support element is located at the inner side of the second corner element 320. The third support element 430 is disposed at the third corner 113 of the optical element drive mechanism 100, and the third support element 430 is located at the inner side of the third corner element 330. The fourth support element 440 is disposed at the fourth corner 114 of the optical element drive mechanism 100, and the fourth support element 440 is located at the inner side of the fourth corner element 340. In some embodiments, the first support element 410, the second support element 420, the third support element 430, and the fourth support element 440 are substantially the same.

The elastic element 450 includes a first suspension portion 451, a second suspension portion 452, a third suspension portion 453, a fourth suspension portion 454, a first extension portion 455, and a second extension portion 456. The first suspension portion 451, the second suspension portion 452, the third suspension portion 453, and the fourth suspension portion 454 are respectively disposed at different corners of the optical element drive mechanism 100.

Specifically, the first suspension portion 451 is located at the first corner 111 of the optical element drive mechanism 100, and the first suspension portion 451 is connected to the first support element 410. The second suspension portion 452 is located at the second corner 112 of the optical element drive mechanism 100, and the second suspension portion 452 is connected to the second support element 420. The third suspension portion 453 is located at the third corner 113 of the optical element drive mechanism 100, and the third suspension portion 453 is connected to the third support element 430. The fourth suspension portion 454 is located at the fourth corner 114 of the optical element drive mechanism 100, and the fourth suspension portion 454 is connected to the fourth support element 440.

The first extension portion 455 extends along the second side 102 of the optical element drive mechanism 100, and the first suspension portion 451 is connected to the second suspension portion 452 via the first extension portion 455. The second extension portion 456 extends along the fourth side 104 of the optical element drive mechanism 100, and the third suspension portion 453 is connected to the fourth suspension portion 454 via the second extension portion 456.

In some embodiments, the first suspension portion 451, the second suspension portion 452, the third suspension portion 453, and the fourth suspension portion 454 have the same or similar dimensions (e.g., width). In addition, the first extension portion 455 and the second extension portion 456 have the same or similar dimensions (e.g., width). In some embodiments, the size of the first suspension portion 451 is smaller than the size of the first extension portion 455.

The circuit assembly 500 can be disposed at the outer side of the holder 230. In some embodiments, the circuit assembly 500 is a flexible circuit board, such as a flexible printed circuit (FPC) or a rigid-flex board. The circuit assembly 500 can be electrically connected to the drive assembly 600 and the sensing assembly 700.

The drive assembly 600 includes a first coil 610, a second coil 620, a third coil 630, a first magnetic element 640, a second magnetic element 650, and a third magnetic element 660. In some embodiments, from a top view, the shape of each of the first coil 610, the second coil 620, and the third coil 630 is similar to an ellipse. In some embodiments, from a top view, the shape of each of the first magnetic element 640, the second magnetic element 650, and the third magnetic element 660 is similar to a rectangle.

The first coil 610, the second coil 620, and the third coil 630 may be disposed on the circuit substrate 370. Specifically, the first coil 610 may be disposed on the second side 102 of the optical element drive mechanism 100. The second coil 620 may be disposed on the third side 103 of the optical element drive mechanism 100. The third coil 630 may be disposed on the fourth side 104 of the optical element drive mechanism 100. That is, the second coil 620 is disposed between the first coil 610 and the third coil 630.

In some embodiments, the first coil 610, the second coil 620, and the third coil 630 have different sizes. For example, the first coil 610, the second coil 620, and the third coil 630 have different sizes along their respective long axes (e.g., lengths). For example, the first coil 610, the second coil 620, and the third coil 630 have different sizes along the main axis MA (e.g., thickness).

The first magnetic element 640, the second magnetic element 650, and the third magnetic element 660 can be disposed on the holder 230, and their positions can correspond to the first coil 610, the second coil 620, and the third coil 630, respectively. Specifically, the first magnetic element 640 may be disposed on the second side 102 of the optical element drive mechanism 100. The second magnetic element 650 may be disposed on the third side 103 of the optical element drive mechanism 100. The third magnetic element 660 may be disposed on the fourth side 104 of the optical element drive mechanism 100. That is, the second magnetic element 650 is disposed between the first magnetic element 640 and the third magnetic element 660.

When current passes through the first coil 610, electromagnetic force can be generated between the first coil 610 and the first magnetic element 640 to drive the circuit substrate 370 and the optical element OE thereon to rotate relative to the holder 230. When current passes through the second coil 620, electromagnetic force can be generated between the second coil 620 and the second magnetic element 650 to drive the circuit substrate 370 and the optical element OE thereon to move along the Y-axis. When current passes through the third coil 630, electromagnetic force can be generated between the third coil 630 and the third magnetic element 660 to drive the circuit substrate 370 and the optical element OE thereon to move along the X-axis. Therefore, the optical element drive mechanism 100 may have an optical image stabilization (OIS) function.

The sensing assembly 700 may include a first sensing element 710, a second sensing element 720, a third sensing element 730, and a control element 740. The first sensing element 710, the second sensing element 720, and the third sensing element 730 may be Hall sensing elements, Giant Magneto Resistance (GMR) sensing elements, tunneling magnetoresistance (Tunneling Magneto Resistance, TMR) sensing elements, etc.

The first sensing element 710, the second sensing element 720, and the third sensing element 730 may be disposed on the circuit substrate 370. The first sensing element 710 is disposed on the second side 102 of the optical element drive mechanism 100. In some embodiments, the first sensing element 710 is disposed inside the first coil 610. The first sensing element 710 can sense the rotation angle of the circuit substrate 370 and the optical element OE thereon relative to the holder 230.

The second sensing element 720 is disposed on the third side 103 of the optical element drive mechanism 100. In some embodiments, the second sensing element 720 is disposed inside the second coil 620. The second sensing element 720 can sense the displacement of the circuit substrate 370 and the optical element OE thereon relative to the holder 230 in the Y-axis direction.

The third sensing element 730 is disposed on the fourth side 104 of the optical element drive mechanism 100. In some embodiments, the third sensing element 730 is disposed inside the third coil 630. The third sensing element 730 can sense the displacement of the circuit substrate 370 and the optical element OE thereon relative to the holder 230 in the X-axis direction.

The control element 740 is disposed on the circuit substrate 370. The control element 740 is disposed on the second side 102 of the optical element drive mechanism 100. In some embodiments, the control element 740 is disposed between the first coil 610 and the second coil 620. In some embodiments, the control element 740 may be a driver IC. In some embodiments, the control element 740 can be an All-in-One integrated circuit (All-in-One IC), which integrates an amplifier circuit, a temperature compensation circuit, a regulated power supply circuit, and the like. After power is supplied to the All-in-One IC by an external power supply, the All-in-One IC can supply power to other elements. In addition, the All-in-One IC has control function.

The first sensing element 710, the second sensing element 720, and the third sensing element 730 can output the sensed results to the control element 740. In addition, the control element 740 can be electrically connected to the first coil 610, the second coil 620, and the third coil 630 to control the movement of the circuit substrate 370. Therefore, through the sensing of the sensing assembly 700, the driving signal input to the drive assembly 600 can be corrected to achieve closed-loop feedback, thereby achieving better displacement correction, better displacement compensation, etc.

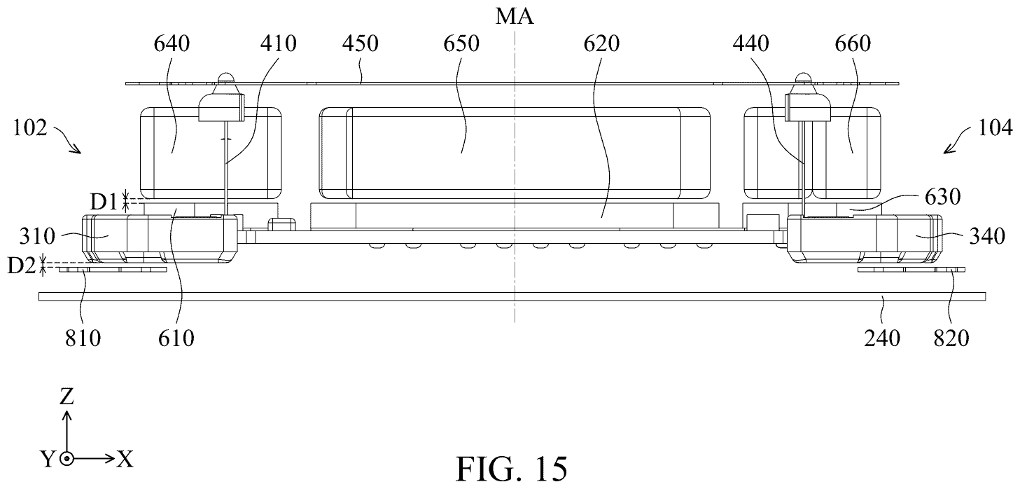

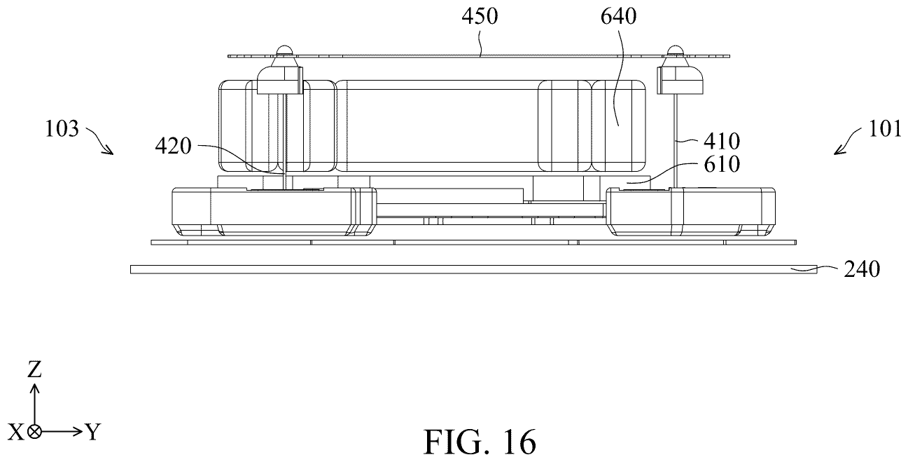

Next, please refer to all the drawings to understand the stopper assembly 800. The stopper assembly 800 can limit the movement of the movable part 300 within a range of motion. FIG. 15 and FIG. 16 are side views of the optical element drive mechanism 100 with the casing 210, the holder 230, and the circuit assembly 500 omitted according to some embodiments.

As described above, the support assembly 400 is connected to the holder 230 and the circuit substrate 370, and the drive assembly 600 can generate the driving force, so that the drive assembly 600 can drive the circuit substrate 370 to move (including move or rotate) relative to the holder 230. During the movement of the movable part 300, it may be desirable to stop the movement of the movable part 300 and the extension of the support assembly 400 to reduce the possibility that the movable part 300 and the support assembly 400 connected to the movable part 300 are damaged because of excessive impact and excessive extension.

The stopper assembly 800 includes a first stopper element 810 and a second stopper element 820. The first stopper element 810 and the second stopper element 820 have plate-like structures. The first stopper element 810 and the second stopper element 820 are disposed below the movable part 300, and the first stopper element 810 and the second stopper element 820 are connected to the immovable part 200. The first stopper element 810 and the second stopper element 820 can be disposed in the accommodation space of the immovable part 200, so the size (i.e., thickness) of the optical element drive mechanism 100 in the main axis MA will not be increased, which is advantageous for the miniaturization of optical element drive mechanism 100.

The first stopper element 810 and the second stopper element 820 are disposed on different sides of the optical element drive mechanism 100. Specifically, the first stopper element 810 is disposed on the second side 102 of the optical element drive mechanism 100, and the second stopper element 820 is disposed on the fourth side 104 of the optical element drive mechanism 100. In some embodiments, the first stopper element 810 and the second stopper element 820 are symmetrically disposed. In some embodiments, the first stopper element 810 and the second stopper element 820 are substantially the same.

The first stopper element 810 may include a first connection portion 811 (only denoted in FIG. 3) and a second connection portion 812 (only denoted in FIG. 3). The first connection portion 811 and the second connection portion 812 are disposed on different sides of the optical element drive mechanism 100. Specifically, the first connection portion 811 may be located on the first side 101 of the optical element drive mechanism 100, and the second connection portion 812 may be located on the second side 102 of the optical element drive mechanism 100.

In some embodiments, the first stopper element 810 and the second stopper element 820 are made of plastic. In the embodiments where the first stopper element 810 and the second stopper element 820 are made of plastic, the first stopper element 810 and the second stopper element 820 can be connected to the casing 210 by an adhesive element (e.g., glue). The adhesive element may be applied to the first connection portion 811 and the second connection portion 812, so that the first connection portion 811 and the second connection portion 812 are firmly connected to the casing 210.

In some embodiments, the first stopper element 810 and the second stopper element 820 are made of metal. In the embodiments where the first stopper element 810 and the second stopper element 820 are made of metal, the first stopper element 810 and the second stopper element 820 can be connected to the casing 210 by welding. The first connection portion 811 and the second connection portion 812 can be used as welding points between the first stopper element 810 and the casing 210, so that the first connection portion 811 and the second connection portion 812 are firmly connected to the casing 210.

Since the first stopper element 810 and the second stopper element 820 can be firmly connected to the casing 210, the shape of the casing 210 can be maintained and the possibility of deformation of the casing 210 can be reduced. Therefore, the structural strength of the casing 210 can be improved, thereby improving the overall structural strength of the optical element drive mechanism 100. It should be noted that the number and size of the connection portions are not limited to the above-described embodiments.

The first stopper element 810 may include a gap 813. The second stopper element 820 may include a gap 823. During the assembly of the optical element drive mechanism 100, whether the assembly of the elements meets expectations can be observed through the gap 813 and the gap 823. For example, the gap 813 and the gap 823 can be used to confirm whether the bending of the circuit assembly 500 meets expectations, so the yield of the assembled optical element drive mechanism 100 can be improved.

The stopper assembly 800 can limit the movement range of the movable part 300. When the movable part 300 is at the lower limit position (that is, the movable part 300 moves downward to the limit and cannot move downward anymore), at least one of the first corner element 310, the second corner element 320, the third corner element 330, and the fourth corner element 340 would be in contact with the corresponding first stopper element 810 or second stopper element 820, so that the movable part 300 cannot continue to move downward. That is, the stopper assembly 800 can limit the downward movement range of the movable part 300 relative to the immovable part 200 along the main axis MA.

In some embodiments, when the movable part 300 is located at the lower limit position, each of the first corner element 310, the second corner element 320, the third corner element 330, and the fourth corner element 340 is in contact with the corresponding first stopper element 810 or second stopper element 820. That is, the first corner element 310 and the second corner element 320 are in contact with the first stopper element 810, and the third corner element 330 and the fourth corner element 340 are in contact with the second stopper element 820.

In this embodiment, the optical element drive mechanism 100 includes two stopper elements (for example, the first stopper element 810 and the second stopper element 820), so the impact force can be effectively dispersed and the overall stability of the optical element drive mechanism 100 can be improved. In some embodiments, there may be only one stopper element (e.g., the first stopper element 810) to reduce the overall weight of the optical element drive mechanism 100.

In the embodiments where the stopper assembly 800 (including but not limited to the first stopper element 810 and the second stopper element 820) and the movable part 300 (including but not limited to the first corner element 310, the second corner element 320, the third corner element 330, and the fourth corner element 340) are made of different materials, the possibility of particles or debris being generated during the stopper assembly 800 coming into contact with the movable part 300 can be reduced.

Due to the stopper assembly 800, the movement of the movable part 300 along the main axis MA can be effectively controlled, thereby reducing the possibility of the movable part 300 being damaged due to excessive impact. Moreover, the degree of deformation of the support assembly 400 can also be ensured, thereby reducing the possibility of the movable part 300 being damaged due to excessive extension.

In addition, the drive assembly 600 can also limit the movement range of the movable part 300. When the movable part 300 is located at the upper limit position (that is, the movable part 300 moves upward to its limit and cannot move upward anymore), at least one of the first coil 610, the second coil 620, and the third coil 630 would be in contact with the corresponding first magnetic element 640, second magnetic element 650, or third magnetic element 660, preventing the movable part 300 from continuing to move upward. That is, the drive assembly 600 can limit the upward movement range of the movable part 300 relative to the immovable part 200 along the main axis MA.

In some embodiments, when the movable part 300 is located at the upper limit position, each of the first coil 610, the second coil 620, and the third coil 630 is in contact with the corresponding first magnetic element 640, second magnetic element 650, or third magnetic element 660. That is, the first coil 610 is in contact with the first magnetic element 640, the second coil 620 is in contact with the second magnetic element 650, and the third coil 630 is in contact with the third magnetic element 660.

In some embodiments, when the movable part 300 has not started to move, the minimum distance DI between the first coil 610 and the first magnetic element 640 in the main axis MA is different from the minimum distance D2 between the first stopper element 810 and the first corner element 310 in the main axis MA. In some embodiments, when the movable part 300 has not started to move, the minimum distance D1 between the first coil 610 and the first magnetic element 640 in the main axis MA is smaller than the minimum distance D2 between the first stopper element 810 and the first corner element 310 in the main axis MA.

In some embodiments, the immovable part 200 further includes a base 240 (only schematically illustrated in FIG. 15 and FIG. 16). The base 240 may be made of metal. The base 240 can be welded to the casing 210. The base 240 is not in contact with the first stopper element 810 and the second stopper element 820. Moreover, due to the protruding portion 214 of the casing 210, the minimum distance between the casing 210 and the base 240 is smaller than the minimum distance between the casing 210 and the first stopper element 810. If the stopper assembly 800 is not provided, the movable part 300 may collide with the base 240 and be damaged.

As described above, the present disclosure provides an optical element drive mechanism. The optical element drive mechanism includes an immovable part, a movable part, a drive assembly, and a stopper assembly. The movable part is connected to the optical element. The movable part is movable relative to the immovable part. The drive assembly drives the movable part to move relative to the immovable part. The stopper assembly may be disposed below the movable part to limit the downward movement range of the movable part. The stopper assembly and the movable part may be made of different materials to reduce the possibility of particles or debris being generated during the movable part coming into contact with the stopper assembly.

The present disclosure provides a suitable stopping method so that the stopper assembly can effectively limit the movement range of the movable part relative to the immovable part and the degree of deformation of the support assembly, thereby reducing the possibility of damage to the movable part and the support assembly. In addition, the stopper assembly can be disposed in the accommodation space of the immovable part, so the thickness of the optical element drive mechanism will not be increased, which is advantageous for the miniaturization of the optical element drive mechanism. In addition, the stopper assembly can be firmly connected to the immovable part to improve the structural strength of the immovable part. Since the stopper assembly can improve the structural strength of the immovable part and reduce the possibility of damage to the movable part and the support assembly, the overall structural strength of the optical element drive mechanism can be improved.

In some embodiments, in addition to driving the movable part to move relative to the immovable part, the drive assembly may also be used as stoppers. In some embodiments, the optical element drive mechanism may further include an optical path adjustment element to have wider applicability.

The foregoing outlines features of several embodiments, so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced in the following description. Those skilled in the art should also realize that such equivalent constructions do not depart from the spirit and scope of the present disclosure, and that they may make various changes, substitutions, and alterations in the following description without departing from the spirit and scope of the present disclosure.

What is claimed is:

1. An optical element drive mechanism, comprising:
an immovable part;
a movable part connected to an optical element, wherein the movable part is movable relative to the immovable part;
a drive assembly driving the movable part to move relative to the immovable part; and
a stopper assembly restricting the movable part to move within a range of motion,
wherein the stopper assembly comprises a first stopper element connected to the immovable part.

2. The optical element drive mechanism as claimed in claim 1, wherein the movable part comprises a first corner element disposed over the first stopper element, and when the movable part is located at a lower limit position, the first corner element is in direct contact with the first stopper element.

3. The optical element drive mechanism as claimed in claim 2, wherein the first stopper element is made of metal.

4. The optical element drive mechanism as claimed in claim 2, wherein the first corner element is substantially L-shaped.

5. The optical element drive mechanism as claimed in claim 2, wherein the movable part further comprises a second corner element, the first corner element and the second corner element are located on different corners of the optical element drive mechanism, and when the movable part is located at the lower limit position, the second corner element is in direct contact with the first stopper element.

6. The optical element drive mechanism as claimed in claim 5, wherein the movable part further comprises an extending element, the first corner element is connected to the second corner element via the extending element, and a thickness of the first corner element is different from a thickness of the extending element.

7. The optical element drive mechanism as claimed in claim 6, wherein the thickness of the first corner element is greater than the thickness of the extending element.

8. The optical element drive mechanism as claimed in claim 6, wherein the first corner element and the extending element are made of different materials.

9. The optical element drive mechanism as claimed in claim 8, wherein the first corner element and the second corner element are made of plastic, and the extending element is made of metal.

10. The optical element drive mechanism as claimed in claim 2, wherein the immovable part comprises a casing, and the casing comprises:
a top wall; and
a side wall connected to the top wall and not parallel with the top wall, wherein the top wall and the side wall form an accommodating space for accommodating the movable part and the stopper assembly,
wherein the first stopper element comprises a first connection portion and a second connection portion, the first connection portion and the second connection portion are located on different sides of the optical element drive mechanism, and the first connection portion and the second connection portion are firmly connected to the casing.

11. The optical element drive mechanism as claimed in claim 10, wherein the stopper assembly further comprises a second stopper element, the first stopper element and the second stopper element are located on different sides of the optical element drive mechanism, and the first stopper element and the second stopper element have plate-like structures.

12. The optical element drive mechanism as claimed in claim 11, wherein the first stopper element and the second stopper element are made of metal, and the first stopper element and the second stopper element are welded to the casing.

13. The optical element drive mechanism as claimed in claim 11, wherein the first stopper element and the second stopper element are made of plastic, and the first stopper element and the second stopper element are firmly connected to the casing via an adhesive element.

14. The optical element drive mechanism as claimed in claim 2, wherein the drive assembly comprises a first coil and a first magnetic element corresponding to the first coil, and when the movable part is located at an upper limit position, the first magnetic element is in direct contact with the first coil.

15. The optical element drive mechanism as claimed in claim 14, wherein in a main axis, a minimum distance between the first coil and the first magnetic element is different from a minimum distance between the first stopper element and the first corner element.

16. The optical element drive mechanism as claimed in claim 14, wherein the drive assembly further comprises a second coil and a third coil, the first coil, the second coil, and the third coil are disposed on different sides of the optical element drive mechanism, and the first coil, the second coil, and the third coil have different sizes along their respective long axes.

17. The optical element drive mechanism as claimed in 16, further comprising a sensing assembly, wherein the sensing assembly comprises a first sensing element disposed inside the first coil, a second sensing element disposed inside the second coil, and a third sensing element disposed inside the third coil.

18. The optical element drive mechanism as claimed in claim 2, further comprising a support assembly, wherein the support assembly comprises a first support element extending along a main axis, a top end of the first support element is connected to the immovable part, and a bottom end of the first support element is connected to the movable part.

19. The optical element drive mechanism as claimed in claim 18, wherein the first support element and the first corner element are disposed at the same corner of the optical element drive mechanism, and the first support element is disposed at an inner side of the first corner element.

20. The optical element drive mechanism as claimed in 18, wherein the support assembly further comprises an elastic element, and the elastic element comprises a first suspension portion connected to the first support element.
